(19) United States
(12) Patent Application Publication
(10) Pub. No.: US 2008/0164300 A1
(43) Pub. Date: Jul. 10, 2008

(54) Method of making circuitized substrate with solder balls having roughened surfaces, method of making electrical assembly including said circuitized substrate, and method of making multiple circuitized substrate assembly

(75) Inventors: David J. Alcoe, Hayward, WI (US); Paul J. Hart, Endicott, NY (US)

Correspondence Address: LAWRENCE R. FRALEY;Hinman, Howard & Kattell, LLP, 700 Security Mutual Building, 80 Exchange Street, Binghamton, NY, 13902-5250, US

(73) Assignee: Endicott Interconnect Technologies, Inc., Endicott, NY (US)

(21) Appl. No.: 11/650,520

(22) Filed: Jan. 8, 2007

(51) Int. Cl. B23K 31/02; B23K 1/20

(52) U.S. Cl. 228/180.22; 228/203

(57) ABSTRACT

A method of making a circuitized substrate (e.g., a chip carrier) with solder balls thereon which are each formed in such a manner so as to have rough surfaces thereon, thereby providing enhanced connections with conductors (e.g., conductive sites) of an electronic device (e.g., a semiconductor chip). Methods of making an electrical assembly including both substrate and device, as well as this assembly and another substrate, thereby forming a multiple substrate assembly, are also provided.

### TECHNICAL FIELD

The invention relates to the manufacture of circuitized substrates such as chip carriers and the like. More specifically, it relates to such substrates which include solder balls (bumps) thereon, e.g., for having an electronic device such as a semiconductor device joined thereto.

### BACKGROUND OF THE INVENTION

Various types of circuitized substrates, including chip carriers, having solder ball elements as part thereof are well known, as evidenced in some of the several U.S. Letters Patents listed below in this Background. One circuitized substrate made and sold by the Assignee of this invention, Endicott Interconnect Technologies, Inc., is the HyperBGA chip carrier, which includes a laminate substrate-conductor layer structure on which may be positioned one or more semiconductor chips. (HyperBGA is a registered trademark of Endicott Interconnect Technologies, Inc.). The carrier is then positioned on and electrically coupled to a printed circuit board (PCB) or other suitable substrate to form a larger assembly such as one used in a personal computer, server, etc. The latter assemblies are often referred to generically in the industry as “information handling systems.” Examples of such a chip carrier are defined in filed U.S. Pat. Nos. 7,023,707 and 7,035,113, both filed Mar. 24, 2003 and assigned to Assignee Endicott Interconnect Technologies, Inc.

The following U.S. Letters Patents describe various substrates and/or solder ball structures in which the solder balls have been treated in one manner or another. As shown in some of these (e.g., U.S. Pat. No. 6,719,185), coining of the solder balls to provide a flattened top surface thereof so enhance the eventual coupling of the solder balls to a second electrical device or component is known. Various other methods and structures for forming solder balls are also described below.

U.S. Pat. No. 7,015,590 describes forming a reinforced solder bump between a contact pad arranged on a semiconductor chip and a pad on a mounting substrate. The chip includes at least one reinforcing protrusion extending upwardly from a surface of an intermediate layer while the mounting substrate includes at least one reinforcing protrusion extending upwardly from its pad, both of these protrusions being embedded within the solder bump connector.

U.S. Pat. No. 6,940,167 describes a solder bump fabrication process that allegedly produces a larger diameter/taller solder ball than with a standard mushroom by forming an elongated mushroom having a short axis in the direction of adjacent connection mushrooms and an elongated axis orthogonal to the short axis. The increased larger volume solder, when reflowed, produces the larger diameter/taller bolder ball bump.

U.S. Pat. No. 6,897,142 describes a method of forming a solder ball which includes the steps of forming an electrode pad on a substrate, forming an insulating layer having a first opening at a position of the electrode pad, filling the first opening with solder paste that include solder and first resin, and applying a heating process to the solder paste so as to form a solder ball on the electrode pad and to form a cured resin member of the first resin across a border between the electrode pad and the substrate.

U.S. Pat. No. 6,872,650 describes a solder ball electrode method which comprises the steps of preparing a semiconductor apparatus having a plurality of electrode pads, arranging a mask having an upper surface and a lower surface (an area in the lower surface being larger than an area in the upper surface and a plurality of openings extended from the upper surface to the lower surface) on a surface of the semiconductor apparatus having the electrode pads formed thereon so that the surface and the lower surface can face each other; arranging solder balls on the electrode pads arranged in the openings from the upper surface side of the mask, and electrically connecting the solder balls to the electrode pads to form ball electrodes.

U.S. Pat. No. 6,861,346 describes a solder ball fabricating process for forming solder balls over a wafer having an active layer. A patterned solder mask layer is formed over the active surface of the wafer. The patterned solder mask layer has an opening that exposes a bonding pad on the wafer. Solder material is deposited into the opening over the bonding pad. A reflow process is conducted to form a “pre-solder” body. The aforementioned steps are repeated so that various solder materials are fused together to form a solder ball over the bonding pad.

U.S. Pat. No. 6,827,252 describes a method of forming solder bumps on the active surface of a silicon wafer. An under-ball metallic layer is formed over the active surface of the wafer. A plurality of first solder blocks is attached to the upper surface of the under-ball metallic layer. Each first solder block has an upper surface and a lower surface. The lower surface of the first solder block bonds with the under-ball metallic layer. The upper surfaces of the first solder blocks are planarized. A second solder block is attached to the upper surface of each first solder block and then a reflow operation is carried out.

U.S. Pat. No. 6,793,116 describes achieving a desired quantity of solder material for a solder joint apparently without increasing the thickness of a solder layer formed. The solder ball comprises a conductive core having “depressions” on its outer surface, and a solder layer formed to cover the outer surface of the core in such a way as to fill the depressions of the core. Thus, the quantity of the solder material included in the ball is supplemented by the solder material filled into the depressions. Preferably, the core has a higher melting point than the solder layer and wettability to the solder layer. The core may have a cavity in its inside, thereby forming a shell-shaped core. The core may be made of a porous metal body having pores, in which part of the pores reaches the outer surface of the core, thereby forming the depressions.

U.S. Pat. No. 6,719,185 describes a method for manufacturing a wiring substrate which includes the steps of applying, through printing, solder paste onto a plurality of pads exposed from the main surface of the substrate; melting the applied solder paste through reflowing, so as to form substantially hemispherical solder bumps; and then flattening top portions of the substantially hemispherical solder bumps through the pressing of a flat pressing surface against the top portions, thereby forming top-flattened solder bumps. A pad is classified as a first pad when the pad is located within a region above a solid layer, and as a second pad when the pad is located outside of this region. In the solder paste application step, the amount of solder paste applied onto each first pad is smaller than that of solder paste applied onto each second pad.

U.S. Pat. No. 6,613,662 describes a bumped semiconductor device contact structure including at least one non-planar contact pad having a plurality of projections extending there-from for contacting at least one solder ball of a bumped integrated circuit (IC) device, such as a bumped die and a bumped packaged IC device. The projections are arranged to make electrical contact with the solder balls of a bumped IC device without substantially deforming the solder ball. Accordingly, reflow of solder balls to reform the solder balls is not necessary. Such a contact pad may be provided on various testing equipment such as probes and the like and may be used for both temporary and permanent connections. Also disclosed is a method of forming the contact pads by etching and deposition.

U.S. Pat. No. 6,607,613 describes a metal alloy solder ball comprising a first metal and a second metal, the first metal having a sputtering yield greater than the second metal. The solder ball comprises a bulk portion having a bulk ratio of the first metal to the second metal, an outer surface, and a surface gradient having a depth and a gradient ratio of the first metal to the second metal that is less than the bulk ratio. The gradient ratio increases along the surface gradient depth from a minimum at the outer surface. The solder ball may be formed by the process of exposing the ball to energized ions of a sputtering gas for an effective amount of time to form the surface gradient.

U.S. Pat. No. 6,464,124 describes a solder ball shaping tool and a method for using the tool. In a substrate, there is formed a series of “depressions”. The tool is pressed onto a ball grid array and the ball grid array is realigned either with simple pressure or pressure assisted by heating. Where a solder ball may have been deposited upon a die or a chip package in a diameter that exceeds that of the designed diameter, a corral tool is used to substantially conform the solder ball to design dimensions and a design location. As the corral tool is pressed against the solder ball, portions of the solder ball will reflow both into the substrate depression and into the corral. Where the total volume of the solder ball does not exceed that of both the corral and the substrate depression, the corral tool is adequate to achieve a designed solder ball height.

U.S. Pat. No. 6,443,351 describes a BGA (Ball Grid Array) package fabrication method for the purpose of achieving solder ball co-planarity on a warped BGA package; that is, one which is either concavely-warped or convexly-warped. The proposed method is characterized in the provision of a plurality of variably-sized solder-ball pads over the bottom surface of the substrate, each solder-ball pad having a specified size predetermined in accordance with pre-measured package warpage and predetermined relation of solder ball height against pad size. This provision allows the use of a solder mask having fixed-size openings, as contrary to the prior art that uses a solder mask having variably-sized openings, to allow the implanted solder balls to achieve co-planarity and have strengthened shear for robust solder joint.

U.S. Pat. No. 6,344,234 describes a method and structure for a solder interconnection, using solder balls for making a low temperature chip attachment directly to any of the higher levels of packaging substrate. After a solder ball has been formed using standard methods, it is reflowed to give the solder ball a smooth surface. A layer of low melting point metal, such as, bismuth, indium or tin, preferably, pure tin, is deposited on the top of the solder balls. This structure results in localizing of the eutectic alloy, formed upon subsequent low temperature joining cycle, to the top of the high melting solder ball even after multiple low temperature reflow cycles. This method allegedly does not need tinning of the substrate to which the chip is to be joined.

U.S. Pat. No. 6,578,755 describes a method of forming a polymer support ring, or collar, around the base of solder balls used to form solder joints which includes forming patterned regions of uncured polymer material over each of the conductive solder bump pads on an IC package or other substrate to which the solder balls are to be attached. The uncured polymer material is a no-flow under-fill material that fluxes the solder bump pads. Pre-formed solder balls are then placed into the uncured polymer material onto their respective solder bump pads. A subsequent heating cycle raises the assembly to the reflow temperature of the solder balls, thereby attaching the solder balls to the underlying solder bump pads, and at least partially curing the polymer material to form a support collar at the base region of each attached solder ball.

U.S. Pat. No. 6,486,054 describes how greater solder ball height can be allegedly achieved without the need to sacrifice area density. The mold in which the solder is formed is created in two steps. In a first exposure, a negative photoresist is patterned to form a conventional cylindrical mold. However, exposure and development time are adjusted in such a way that a layer of unexposed and undeveloped resist of reduced thickness remains covering the floor of the mold. This residual resist layer is given a second exposure and, after development, forms an annular insert in the bottom of the first mold. After the mold has been filled with solder (either through electroplating or by using solder paste) it is removed, the result being a solder bump made up of two contiguous coaxial cylinders, the upper one having the larger diameter. After re-melt, bumps having this shape form oblate spheroids rather than spheres.

U.S. Pat. No. 6,414,974 describes solder bumps with improved co-planarity in a structure comprising a substrate, a passivation layer, a plurality of Under Ball Metallurgy (UBM) layers and the plurality of solder bumps. The substrate has at least an active surface, and a plurality of bonding pads are provided thereon. The UBM layers with various areas are electrically connected to the bonding pads. Finally, the solder bumps are formed with uniform-height on the UBM layers. A method of forming solder bumps with improved co-planarity. A UBM structure with various sizes of openings is provided to control the volume of the solder, wherein the various sizes of openings are corresponding to the current distribution across the wafer. The purpose of the various openings is to control the volume of the solder in order to form uniform-heights of solder bumps, the co-planarity of the solder bumps can thus be improved.

U.S. Pat. No. 6,358,834 describes a method of forming metal bumps on a wafer which includes the steps of adhering a heat-resistant and steady synthetic tape on the top of the wafer, punching holes through the synthetic tape to form a blind hole on the synthetic tape above the UBM layer, filling solder paste into the blind hole by a pusher, melting and then cooling the solder paste into a solder block removing the synthetic tape to expose the solder block, and melting the solder block to form a ball-shaped solder bump.

U.S. Pat. No. 6,264,097 describes using screen printing for forming a higher solder ball (bump). In a first printing step, a first solder layer is printed. After drying, a second solder layer is printed on the first solder layer in a second printing step. Then, in a re-flow processing step, the first solder layer and the second solder layer are melted. Finally, the melted layer is solidified in a ball shape to form the solder ball (bump). Since solder paste is printed in layers, an amount of the solder paste can be increased. Hence, a higher solder ball (bump) can be formed.

U.S. Pat. No. 6,220,499 describes a semiconductor device having controlled collapse chip connection (“C-4”) solder connections joining the chip to a chip carrier having pads suitable for receiving the solder connections. Sacrificial solder is formed on the chip carrier pads and then planarized to result in a good, planar surface profile for joining to the semiconductor device

U.S. Pat. No. 6,179,200 describes a method for forming solder balls that have improved height on an electronic substrate such as a silicon wafer. In the method, after solder bumps are deposited by a conventional method such as evaporation, electroplating, electro-less plating or solder paste screen printing, the solder bumps are re-flown on the substrate in an upside-down position such that the gravity of the solder material pulls down the solder ball and thereby increases its height. It is stated in this patent that a minimum of five percent height increase has been achieved.

U.S. Pat. No. 6,088,914 describes a method for mounting an integrated circuit which includes a plurality of solder balls arrayed on the bottom surface of a package of the integrated circuit onto a circuit board. These solder balls provide for surface mounting of the integrated circuit to a circuit board by solder reflow. The array of solder balls can be planarized so that each of the plural solder balls participate in defining a truly planar solder ball contact array for the integrated circuit package. The planarized solder ball contact array affords reliability in forming of surface-mount electrical connections between the integrated circuit package and the circuit board on which the package is to mount. Additionally, the planarized solder ball contacts locally compensate individually for warpage of the integrated circuit package by variation in the individual dimensions of dependency of each solder ball below the bottom surface of the package.

U.S. Pat. No. 5,795,818 describes an interconnection between bonding pads on an integrated circuit chip and corresponding bonding contacts on a substrate. To form the interconnection, a “metallization” is formed on each of the substrate bonding contacts. Metal ball bond bumps are formed on selective ones of the bonding pads and then coined. The substrate and integrated circuit chip are heated. The coined ball bond bumps are then placed into contact with the corresponding metallizations, pressure and ultrasonic energy are applied, and a metal-to-metal bond is formed between each coined ball bond bump and the corresponding metallization.

U.S. Pat. No. 5,435,482 describes the planarizing of solder balls on the bottom of an integrated circuit package in preparation for joining the package to a circuit board. The solder balls are planarized by pressing on a platen which may be heated. The solder balls are reflowed upon joining to the circuit board. This patent describes the solder balls being planarized to mitigate warping or bowing of the integrated circuit package, as shown in FIG. 5 of this patent.

U.S. Pat. No. 5,324,892 describes the joining of solder columns to a substrate. The columns are planarized so that each is of the same height as the others. These are then are joined to a second substrate by applying a further quantity of solder to the solder columns or the second substrate.

U.S. Pat. No. 5,167,361 describes the flattening of solder bumps on a printed circuit board in preparation for joining to a surface mounted component, e.g., an integrated circuit device. Flattening may be by a vice and platen or by cutting with a circular blade, saw or Q-cutter. Once the contact points of a surface mounted component make contact with the flattened solder, the solder is then reflowed.

U.S. Pat. No. 4,752,027 describes solder bumps being applied to a printed circuit board and then flattened by a roller. A surface mountable component is placed on the flattened solder bumps and then the solder bumps are reflowed.

U.S. Pat. No. 4,661,192 describes applying solder balls to an integrated circuit die, flattening the solder balls by pressing against a platen (the solder balls may be heated) and then joining the integrated circuit die to a die support frame by the use of conductive epoxy.

As defined herein, the present invention defines an improved method of planarizing an array of solder balls to provide an enhanced connection between the solder balls and the electronic device (e.g., a semiconductor chip) to which the solder balls are bonded. The invention also defines an electrical assembly which includes a substrate, the solder balls and electronic device. It is believed that such a method and electrical assembly will represent significant advancements in the art.

### OBJECTS AND SUMMARY OF THE INVENTION

It is, therefore, a primary object of the present invention to enhance the art of substrate manufacture.

It is another object of this invention to provide a method of making a substrate in which solder balls formed thereon possess enhanced connectivity properties to enable facile, sound electrical connections to electronic devices such a semiconductor chips.

It is yet another object of the invention to provide such a method which can be performed in an efficient, effective manner, utilizing, for the most part, known manufacturing equipment.

According to one aspect of the invention, there is provided a method of making a circuitized substrate comprising providing a substrate including at least one dielectric layer having an external surface, providing a plurality of electrical conductors spacedly positioned on the external surface, positioning a plurality of solder balls on the substrate, selected ones of these solder balls being positioned on a respective one of the plurality of electrical conductors positioned on said external surface of said substrate and engaging the selected ones of the solder balls with a coining device so as to form a rough surface on a portion of each of said solder balls.

According to another aspect of the invention, there is provided a method of making an electrical assembly which comprises providing a substrate including at least one dielectric layer having an external surface, providing a plurality of electrical conductors spacedly positioned on the external surface, positioning a plurality of solder balls on the substrate, selected ones of these solder balls being positioned on a respective one of the plurality of electrical conductors positioned on said external surface of said substrate, engaging the selected ones of the solder balls with a coining device so as to form a rough surface on a portion of each of said solder balls, positioning an electronic device having conductive sites thereon on the rough surfaces of the solder balls such that selected ones of the conductive sites will align with and engage respective ones of the rough surfaces of the solder balls, applying a predetermined amount of pressure on the electronic device and/or substrate such that the rough surfaces of the selected ones of the solder balls will at least partially penetrate selected ones of conductive sites of the electronic device, and heating the solder balls to re-flow the solder balls and form an electrical connection between each of the solder balls and respective ones of conductive sites.

According to yet another aspect of the invention, there is provided a method of making a multiple circuitized substrate assembly, the method comprising providing a first substrate including a plurality of electrical conductive members thereon, providing a second substrate including at least one dielectric layer having an external surface, spacedly positioning a plurality of electrical conductors on the external surface, positioning a plurality of solder balls on the second substrate such that selected ones of these solder balls are positioned on a respective one of the plurality of electrical conductors, engaging the selected ones of the solder balls with a coining device so as to form a rough surface on a portion of each of said solder balls, positioning an electronic device having conductive sites thereon on the rough surfaces of the solder balls such that selected ones of the conductive sites will align with and engage respective ones of the rough surfaces of the solder balls, and positioning the second substrate having the electronic device thereon on the first substrate and electrically coupling the second substrate to the first substrate.

### BRIEF DESCRIPTION OF THE DRAWINGS

FIGS. 1-3 are side elevational views, partly in section and on a much enlarged scale, showing the steps of making a circuitized substrate according to one embodiment of the invention; and

FIG. 4 is a side elevational view, partly in section and on a smaller scale than FIGS. 1-3, illustrating one embodiment of a multiple circuitized substrate assembly made using the teachings herein.

### BEST MODE FOR CARRYING OUT THE INVENTION

For a better understanding of the present invention, together with other and further objects, advantages and capabilities thereof, reference is made to the following disclosure and appended claims in connection with the above-described drawings. It is understood that like numerals will be used to indicate like elements from FIGURE to FIGURE.

By the term “circuitized substrate” as used herein is meant to include substrates having at least one (and preferably more) dielectric layer(s) and at least one (and preferably more) electrically conductive layer(s). If more than each type of layers is used, these layers are typically arranged in an alternating manner. Examples of dielectric materials usable for such substrates include fiberglass-reinforced epoxy resins (some referred to as “FR4” dielectric materials in the art, for the flame retardant rating of same), polytetrafluoroethylene (e.g., Teflon), polyimides, polyamides, cyanate resins, photo-imageable materials, and other like materials. Examples of conductor materials usable in the conductive layer(s) for such substrates include copper or copper alloys, but may include or comprise additional metals (e.g., nickel, aluminum, etc.) or alloys thereof. Such conductor materials are used to form layers which may serve as power, signal and/or ground layers. If as a signal layer, several conductor lines and/or pads may constitute the layer, while if used as power or ground, such layers will typically be of substantially solid construction. Combinations of both signal and power and/or ground layers are possible. Examples of circuitized substrates include printed circuit boards (or cards) and, as mentioned above, chip carriers. It is believed that the teachings of the instant invention may also be applicable to what are known in the art as “flex” (thin) circuits (which use dielectric materials such as polyimide).

By the term “electrical assembly” as used herein is meant at least one circuitized substrate as defined herein in combination with at least one electronic device (defined below) electrically coupled thereto and forming part of the assembly. Examples of known such assemblies include chip carriers which include a semiconductor chip bonded thereto, the chip usually positioned on the substrate and coupled to wiring (e.g., pads) on the substrate's outer surface or to internal conductors using one or more thru-holes. The term as used is also broad enough to encompass a printed circuit board having a chip carrier or other electrical structure thereon.

By the term “electronic device” as used herein is meant components such as semiconductor chips and the like which are adapted for being positioned on the external conductive surfaces of circuitized substrates and electrically coupled to the substrate for passing signals from the component into the substrate whereupon such signals may be passed on to other components, including those mounted also on the substrate, as well as other components such as those of a larger electrical system which the substrate forms part of.

By the term “information handling system” as used herein shall mean any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as servers, mainframes, etc.

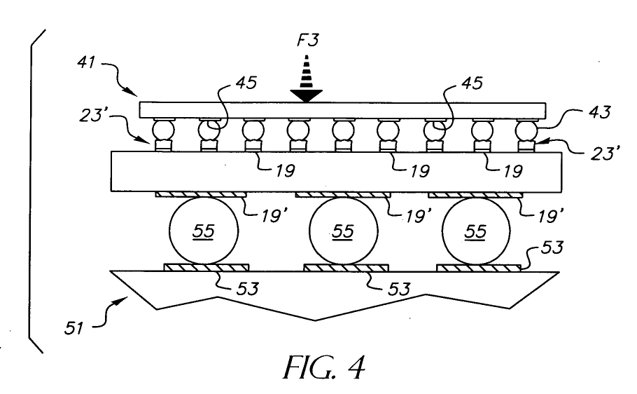

By the term “rough” as used herein to define the surfaces of the solder balls treated using the apparatus and method defined herein is meant an RMS (Root Mean Square) surface roughness within the range of from about ten to about 125 microinches, with a mean peak spacing (average distance between peaks) within the range of from about 100 to about 1000 microinches (a microinch being equal to 0.0254 microns). With such dimensions, a Peak-To-Valley (PTV) value will be from about three to about five times the RMS value. The term “rough” as used herein is not meant to include a surface with upstanding dendritic (growth) projections or singular protrusions (such as the singular protrusions 302B in FIGS. 4A and 4B in the above cited U.S. Pat. No. 5,795,818). In comparison, the “polished” surface of a known coining tool used for solder bump flattening (e.g., such as described in one or more of the above patents which mention such flattening) typically possesses an RMS value of only about three microinches. The “rough” surfaces of the solder balls treated in accordance with the teachings herein are thus, at a minimum, greater than three times the “roughness” of this “polished” surface, and, in many circumstances, many more times greater than this (e.g., up to about forty-two times).

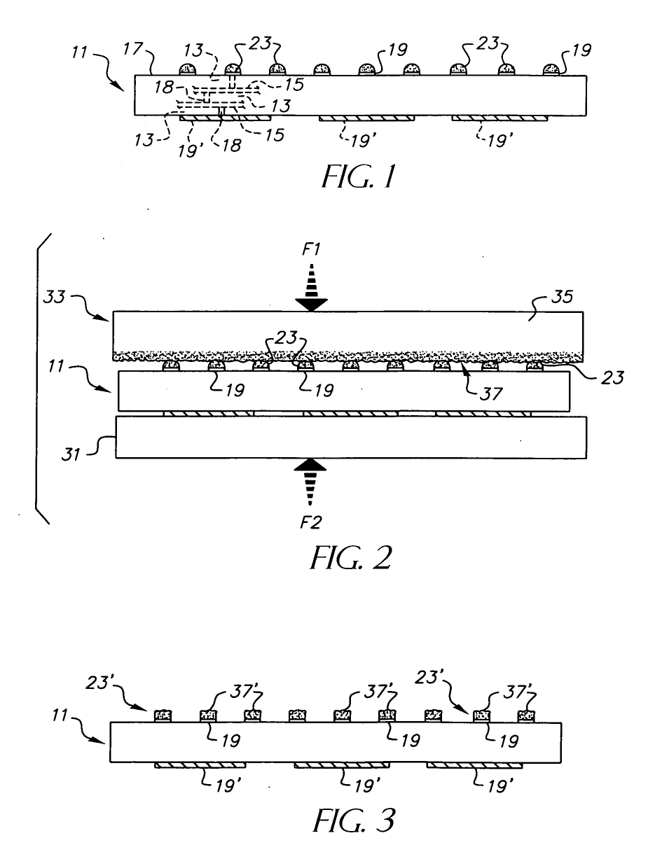

In FIG. 1, there is shown a substrate 11 for use herein, substrate 11 including at least one dielectric layer 13 and, preferably, one or more conductive layers 15 (shown hidden) therein. In one embodiment, a total of eight dielectric layers 13 and nine conductive layers 15 may be used. Layers 13 are of one or more of the above dielectric materials, while layers 15 are of one or more of the above conductive materials. Layers 15 may serve as signal, power and/or ground layers, depending on the operational requirements of the final product utilizing substrate 11. If of a plurality of dielectric and conductive layers, these may be formed using conventional lamination processing known in the PCB and chip carrier art. In its simplest form, however, substrate 11 need only comprise one dielectric layer. On an upper, external surface 17 of substrate 11 are formed a plurality (nine shown) of electrical conductors 19, which are preferably of copper or copper alloy and formed utilizing conventional photolithography processing known in the PCB and chip carrier art. Further description of such processing (and the aforementioned lamination processing) is not deemed needed. If more than one conductive layers are used, connections there-between may be accomplished utilizing conventional thru-hole processing, one example being to form holes in the dielectric using lasers and thereafter coating the internal walls with conductive metallurgy (e.g., copper). This processing is also known in the PCB and chip carrier art and further explanation not considered necessary. These thru-holes are represented by the numerals 18.

In one example of the invention, substrate 11 may include a thickness of about eighteen mils (a mil being one thousandths of an inch), with conductors 19 each having a thickness of about 0.5 mils. In such an example, as many as 7200 conductors 19 may be formed, to accommodate a similar number of conductive sites (defined below) on an electronic device (e.g., a semiconductor chip) which is to be positioned on substrate 11 and electrically coupled thereto. These conductors 19 may occupy a pattern on only part of the upper surface 17, and there may be more than one such pattern, if the substrate is to accommodate more than one such electronic device. The invention is thus not limited to a single device and substrate combination.

In a preferred embodiment, substrate 11 is to eventually become a chip carrier adapted for being positioned on and electrically coupled to another substrate (i.e., substrate 51, FIG. 4) such as a PCB to form a multiple substrate assembly. As such, substrate 11 includes a second plurality of electrical conductors 19′ on the undersurface thereof, these second conductors formed preferably in a similar manner as conductors 19. The hidden lines within substrate 111 are intended to show that connections are formed between both opposing pluralities of conductors 19 and 19′, which, as shown, may be achieved using strategically located conductive thru-holes 18. The illustrations in hidden are not limiting of the various means for providing such connections, as it is well within the scope of this invention to provide many alternative orientations. As defined further below, the undersurface conductors 19′ are designed for being electrically coupled to respective conductive members on the host substrate.

According to the teachings of this invention, a plurality of solder balls 23 is formed atop respective ones of the conductors 19. In one embodiment, this involves positioning a quantity of solder paste atop each conductor 19 and thereafter heating the paste to re-flow it to form a plurality of ball-like solder members. Paste dispensing is accomplished using conventional dispensing equipment, and, in one embodiment, from about ten to about 100 cubic mils of such paste is deposited on each conductor 19. Re-flow is accomplished in a standard convection oven, preferably at a temperature from about 220 degrees Celsius (C) to about 260 degrees C. The solder in this particular embodiment is a 63:37 tin-lead solder, meaning that the lead content is approximately 37 percent. Other solders, e.g., 3:97 tin-lead solder, are also readily usable in this invention and the invention is not limited to this particular solder composition.

Following re-flow of the solder and the formation of the ball-like solder elements, the solder is allowed to cool, e.g., for a time period of ten minutes, following removal from the convection oven. When cooled, the solder elements will have the substantially rounded upper surfaces illustrated in FIG. 1. In some conventional processing, it was now common to planarize the formed solder balls using a planarizing, coining fixture (not shown) having a smooth engaging surface (the above example describes this surface as having an RMS value of about three microinches). It is believed that such a smooth surface is considered necessary for two reasons: (1) to assure the precise, final level of planarity essential for the coined solder balls on such a small, compact structure; and (2) to assure effective separation from the coined solder balls following the coining. Understandably, lack of planarity in the formed structure may prevent effective electrical coupling between one or more of the coined solder balls and the corresponding contacts, e.g., the conductive sites of a semiconductor chip, rendering the assembly inoperative. Ineffective coining tool separation may result in damage or removal of one or more of the solder balls, which will render the substrate unacceptable for eventual device accommodation. In either case, product yields will be reduced and the costs of manufacturing such products increased.

Significantly, and surprisingly, the instant invention is able to provide precise planarizing of such compact arrays of solder balls in addition to enhancing the resulting connections formed between the solder balls and their respective conductors, while not adversely affecting separation of the tooling used and the solder balls. How this is achieved will be defined below with respect to FIG. 2.

In FIG. 2, substrate 11, having the cooled, rounded (and solidified) solder balls 23 thereon, is positioned on a support 31. Any suitable supporting base structure will suffice, including conventional structures as used in the previous coining operations, and further definition is not needed. With the substrate and solder balls in position, the solder balls are engaged by the new and unique coining device 33 of the invention, this device including a body portion 35 having a rough lower surface 37. Surface 37 (much exaggerated in depth in the drawing for illustration purposes) includes a RMS surface roughness within the range of from about ten to about 125 microinches, with a mean peak spacing (average distance between peaks) within the range of from about 100 to about 1000 microinches. Understandably, this is many times rougher than the known, “smooth” coining device mentioned above. Surprisingly, it has been learned that the cooled solder balls may be positively engaged in such a manner by surface 37 that the surfaces will each possess a similar RMS roughness as present on surface 37. However, subsequent device separation is still effectively accomplished without damage or solder ball separation from its respective conductor 19. The unique advantage of such roughened surfaces will be better understood from the following description. Device 33 is preferably comprised of stainless steel with the desired roughness achieved using an etching process. Other means are possible for forming the roughened surface 37, and the invention is not limited to etching. Device 33 engages solder balls 23 by exerting a predetermined force (F19 in FIG. 2) on the device. Additional (than the countering) force (i.e., F2) may also be applied to the undersurface of support 31, albeit it is also possible to simply allow substrate 111 to remain in position on the support without such additional force application. Whichever approach is used, a total of from about six pounds to about forty-four pounds of force is applied in one embodiment of the invention, to a total of one hundred solder balls. This is not meant to limit the invention, however, as it is possible to use more or less force, depending on the number of solder balls being coined, the sizes of such solder balls, and, equally significant, the composition of same. In one embodiment, the solder balls are provided with such rough surfaces while at room temperature. It is also within the scope of the invention to perform this coining operation at an elevated temperature, to the extent that the outer surfaces of the solder balls are somewhat “softened” and thus require correspondingly less force to engage. If this approach is undertaken, engagement may occur at a temperature above about 50 degrees C., including up to a temperature of about 150 degrees C. or higher, again depending on the chemical composition, size, and number of solder balls being treated. It is also possible to combine the coining operation of the present invention with other operations, such as exposing the solder balls to energized ions of a sputtering gas for an effective amount of time to form a desired surface gradient (e.g., prior to coining, or, subsequent thereto) on each solder ball. One example of such a procedure is described in U.S. Pat. No. 6,607,613 cited above.

The result of the above engagement is a circuitized substrate 111 having conductors 19 thereon with coined, roughened (on the top surfaces only) solder ball elements now formed on the conductors, as seen in FIG. 3. These roughened surfaces (greatly exaggerated in FIG. 3 for illustration purposes) are similar in roughness to surface 37 of device 33, and are now represented by the numeral 37′. The solder ball array is planar, despite the inclusion of the roughened surfaces, to assure satisfactory coupling to the designated conductors (below) to form sound electrical connections therewith. The above process has thus resulted in the simultaneous planarizing and roughening of the solder ball array. The circuitized substrate of FIG. 3 is now ready for further processing.

In FIG. 4, substrate 11 is shown having an electronic device 41 positioned thereon (thus forming an electrical assembly as defined above). In one embodiment, this is accomplished by securing a plurality of solder balls 43 to respective conductive sites 45 (e.g., aluminum pads) of the device (e.g., a semiconductor chip) using a conventional solder attach process known for such chip attachment. The device is first positioned in a “site-up” orientation and the solder balls are dispensed in paste form onto the respective conductive sites 45. The paste is then re-flowed to form a substantially ball-like configuration. According to the teachings herein, device 41 is now inverted and aligned relative to the underlying substrate 11 and its coined and roughened solder balls, now represented by the numeral 23′ (also in FIG. 3). Conventional alignment and placement equipment is used for this purpose. The result in a precise alignment between the device's solder balls 43 and the now supporting solder balls 23′ of substrate 11. During conventional processing of such substrate-device electrical assemblies, it is commonplace (and deemed necessary) to now inspect the assembly (e.g., for precise alignment). Such inspection may occur at a different location from the alignment and positioning equipment, which necessitates moving the assembly from the equipment to the inspection station. Considering the extremely small elements of these assemblies, even the slightest undesirable movement (e.g., vibration) during such movement may result in misalignment of said elements. To prevent such misalignment, the process of the instant invention involves a procedure in which the device 41 is engaged by a force (i.e., “F3”) to press the solder balls 43 slightly downwardly onto the roughened surfaces 37′. As with the force applied in FIG. 2, this force application may be onto the device's upper surface (as shown) with the underlying substrate 11 merely held in position on a suitable support. Alternatively, additional force may also be applied from the substrate's underside. A total of from about five to about 200 milligrams-per-ball force may be applied for up to ten seconds, depending on the number of solder balls and the composition thereof. In one example in which 2200 solder balls 43 having a 3:97 tin-lead composition are used, the applied force may be approximately 150 grams and applied for less than a second. Significantly, this tiny force is sufficient to cause the roughened surfaces 37′ of solder balls 23′ to partially penetrate the surface of respective solder balls 43, in part due to the roughened surface providing increased localized contact pressure. This penetration in turn is sufficient to create a frictional force necessary to retain the device in precise orientation over the substrate during movement of the substrate-device assembly on to the inspection station, and subsequently the reflow oven chambers, of the assembly line. This understandably represents a significant feature of the present invention.

Once inspection and/or other processing has occurred, the assembly including the substrate and device positioned thereon is subjected to a re-flow procedure in which the solder balls 23′ and 43 are re-flowed, each pair forming a continuous mass of solder which, when cooled, assumes a substantially ball-like configuration. In one example, this re-flow procedure is accomplished in a convection oven at a temperature within the range of from about 220 degrees C. to about 260 degrees C., for a time period of from about one minute to about three minutes. These parameters of course depend on the particular solder compositions and sizes of the solder balls used, and may vary accordingly.

The substrate 11 and device 41 electrical assembly is now ready for placement on a second substrate 51 (e.g., a printed circuit board) and electrically coupled thereto. Understandably, substrate 51 was not in position as shown in FIG. 4 during the aforementioned application of force “F3.” In one embodiment, substrate 51 includes a plurality of conductive members 53 on its top surface, oriented in a pattern similar to the pattern of the conductors 19′ on the assembly's undersurface. Conductive members 53 may be in the form of copper or copper alloy pads of rectangular or annular configuration, having a thickness of from about 0.5 mils to about two mils. These conductive members may be formed on the substrate's upper surface utilizing conventional photolithography processing known in the art. Coupling between members 53 and respective ones of the undersurface conductors 19′ is preferably accomplished using a plurality of solder balls 55, and in one example, 63:37 tin-lead solder balls each having a diameter of about twenty-five mils. Ball 55 placement may occur by positioning the balls on the undersurface conductors 19′ when the assembly in inverted and the conductors oriented in a face-up orientation. These balls may be deposited initially in paste form and then re-flowed to form a ball-like configuration for each. If so, the re-flow temperatures may range from about 220 degrees C. to about 260 degrees C., for a time period of from about one minute to about three minutes. The assembly may then be inverted and the cooled solder balls 55 then aligned with and positioned on respective ones of the host conductive members 53. Re-flow may again occur, securing the balls in their final position. The result is a multiple circuitized substrate (substrates 11 and 51) assembly with at least one electronic device (chip 41) also as part thereof. This assembly is now capable of being utilized in such information handling products as personal computers, mainframes and servers, as well as in other products.

It is within the scope of this invention to use similar solder compositions for all of the solder elements defined above. If so, similar re-flow temperatures may be utilized, as well as dual re-flow of some solder elements already in place when the second plurality are re-flowed. It is of course also possible to use different combinations of different melting point solders. The invention is adaptable to all such combinations.

As stated above, a preferred example of one product (electrical assembly) utilizing the substrate taught herein is a laminate chip carrier or the like such as that made and sold by the Assignee of the invention under the product name HyperBGA. The invention is not limited, however, to the manufacture of such substrates but instead is applicable to many other circuitized substrates, e.g., PCBs, known in the art. That is, it is within the scope of this invention to also provide such roughened surfaces on solder elements (i.e., solder balls 55) formed on the upper conductors of such PCB's, and use such solder elements to then connect the PCB to an electrical assembly (e.g., chip carrier) or electronic device (e.g., chip) positioned thereon.

While there have been shown and described what at present are considered the preferred embodiments of the invention, it will be obvious to those skilled in the art that various changes and modifications may be made therein without departing from the scope of the invention as defined by the appended claims.

What is claimed is:

1. A method of making a circuitized substrate, said method comprising:
providing a substrate including at least one dielectric layer having an external surface;
providing a plurality of electrical conductors spacedly positioned on said external surface of said at least one dielectric layer;
positioning a plurality of solder balls on said substrate, selected ones of said solder balls being positioned on a respective one of said plurality of electrical conductors positioned on said external surface of said at least one dielectric layer; and
engaging said selected ones of said solder balls with a coining device so as to form a rough surface on a portion of each of said selected ones of said solder balls.

2. The method of claim 1 wherein said engaging of said selected ones of said solder balls with said coining device so as to form said rough surface on said portion of each of said selected ones of said solder balls simultaneously planarizes said selected ones of said solder balls.

3. The method of claim 1 wherein said positioning of said plurality of solder balls on said substrate is accomplished by providing said plurality of solder balls in paste form.

4. The method of claim 3 further including heating said plurality of solder balls positioned on said substrate in paste form sufficiently to re-flow said plurality of solder balls positioned on said substrate, said heating and re-flow occurring prior to said engaging said selected ones of said solder balls with said coining device so as to form said rough surface on said portion of each of said selected ones of said solder balls.

5. The method of claim 4 wherein said heating of said plurality of solder balls positioned on said substrate in paste form sufficiently to re-flow said plurality of solder balls positioned on said substrate is accomplished using a convection oven.

6. The method of claim 4 wherein said heating of said plurality of solder balls positioned on said substrate in paste form sufficiently to re-flow said plurality of solder balls positioned on said substrate is accomplished at a temperature within the range of from about 220 degrees Celsius to about 260 degrees Celsius.

7. The method of claim 1 wherein said providing said plurality of electrical conductors spacedly positioned on said external surface is accomplished using photolithographic processing.

8. The method of claim 1 wherein said engaging of said selected ones of said solder balls with said coining device so as to form said rough surface on a portion of each of said selected ones of said solder balls is performed at a temperature above 50 degrees Celsius.

9. A method of making an electrical assembly, said method comprising:
providing a substrate including at least one dielectric layer having an external surface;
providing a plurality of electrical conductors spacedly positioned on said external surface of said at least one dielectric layer;
positioning a first plurality of solder balls on said substrate, selected ones of said first plurality of solder balls being positioned on a respective one of said plurality of electrical conductors positioned on said external surface of said at least one dielectric layer;
engaging said selected ones of said first plurality of solder balls with a coining device so as to form a rough surface on a portion of each of said selected ones of said first plurality of solder balls;
providing an electronic device having conductive sites thereon;
positioning a second plurality of solder balls on said conductive sites of said electronic device;
positioning said electronic device having said second plurality of solder balls thereon over said substrate such that selected ones of said second plurality of solder balls engage a respective one of said rough surfaces of said respective one of said first plurality of solder balls on said substrate;
applying a predetermined amount of pressure on said electronic device and/or said substrate such that said rough surfaces of said selected ones of said first plurality of solder balls on said substrate will at least partially penetrate said second plurality of solder balls on at least some of said conductive sites of said electronic device; and
heating said selected ones of said first and second plurality of solder balls to re-flow said solder balls and form an electrical connection between each of said electrical conductors and respective ones of said conductive sites.

10. The method of claim 9 further including moving said substrate having said electronic device thereon to an inspection and/or other work station prior to said heating of said selected ones of said first and second plurality of solder balls to re-flow said solder balls and form an electrical connection between each of said electrical conductors and respective ones of said conductive sites.

11. The method of claim 9 wherein said engaging of said selected ones of said first plurality of solder balls with said coining device so as to form said rough surface on said portion of each of said selected ones of said first plurality of solder balls simultaneously planarizes said selected ones of said first plurality of solder balls.

12. The method of claim 9 wherein said positioning of said second plurality of solder balls on said electronic device is accomplished by providing said second plurality of solder balls in paste form.

13. The method of claim 12 further including heating said second plurality of solder balls positioned on said electronic device in paste form sufficiently to re-flow said second plurality of solder balls.

14. The method of claim 13 wherein said heating of said first plurality of solder balls positioned on said substrate in paste form sufficiently to re-flow said first plurality of solder balls positioned on said substrate and said heating of said second plurality of solder balls to re-flow said second plurality of solder balls is accomplished using a convection oven.

15. The method of claim 13 wherein said heating of said first plurality of solder balls positioned on said substrate in paste form sufficiently to re-flow said plurality of solder balls positioned on said substrate is accomplished at a temperature within the range of from about 220 degrees Celsius to about 260 degrees Celsius and said heating of said selected ones of said second plurality of solder balls on said electronic device to re-flow said second plurality of solder balls is accomplished at a temperature within the range of from about 220 degrees Celsius to about 260 degrees Celsius.

16. The method of claim 9 wherein said providing said plurality of electrical conductors spacedly positioned on said external surface of said substrate is accomplished using photolithographic processing.

17. A method of making a multiple circuitized substrate assembly, said method including:
providing a first substrate including a plurality of electrical conductive members thereon;
providing a second substrate including at least one dielectric layer having an external surface;
providing a plurality of electrical conductors spacedly positioned on said external surface of said at least one dielectric layer;
positioning a first plurality of solder balls on said second substrate, selected ones of said solder balls being positioned on respective ones of said plurality of electrical conductors positioned on said external surface of said at least one dielectric layer;
engaging said selected ones of said first plurality of solder balls with a coining device so as to form a rough surface on a portion of each of said selected ones of said first plurality of solder balls;
providing an electronic device having conductive sites thereon;
positioning a second plurality of solder balls on said conductive sites of said electronic device;
positioning said electronic device having said second plurality of solder balls thereon over said first substrate such that selected ones of said second plurality of solder balls engage a respective one of said rough surfaces of said respective one of said first plurality of solder balls on said substrate; and
positioning said second substrate having said electronic device thereon on said first substrate and electrically coupling said second substrate to said first substrate.

18. The method of claim 17 wherein said second substrate further includes a second plurality of electrical conductors positioned on a second external surface opposite said external surface having said selected ones of said plurality of electrical conductors thereon, said positioning of said second substrate having said electronic device thereon on said first substrate and electrically coupling said second substrate to said first substrate being accomplished using a third plurality of solder balls, said third plurality of solder balls interconnecting selected ones of said second plurality of electrical conductors on said second substrate to respective ones of said plurality of electrical conductive members on said first substrate.

19. The method of claim 18 further including heating said third plurality of solder balls to a pre-established temperature to re-flow said third plurality of solder balls to accomplish said interconnecting of said selected ones of said second plurality of electrical conductors on said second substrate to said respective ones of said plurality of electrical conductive members on said first substrate.

20. The method of claim 19 wherein said heating of said third plurality of solder balls is accomplished at a temperature within the range of from about 220 degrees Celsius to about 260 degrees Celsius.

21. The method of claim 19 wherein said heating of said third plurality of solder balls is accomplished using a convection oven.

22. The method of claim 17 further including heating said selected ones of said first and second plurality of solder balls to re-flow said first and second pluralities of solder balls to form an electrical connection between each of said electrical conductors and respective ones of said conductive sites of said electronic device, said heating occurring prior to said positioning of said second substrate having said electronic device thereon on said first substrate and electrically coupling said second substrate to said first substrate.
